(19) United States
(12) Patent Application Publication
(10) Pub. No.: US 2011/0111104 A1
(43) Pub. Date: May 12, 2011

(54) HOLLOWING APPARATUS FOR MEAT PATTIES

(76) Inventors: Verne Edward Thompson, Hazel Park, MI (US); Wei Chieh Tu, Forest Hills, NY (US)

(21) Appl. No.: 12/912,483

(22) Filed: Oct. 26, 2010

Related U.S. Application Data
(60) Provisional application No. 61/254,816, filed on Oct. 26, 2009.

(51) Int. Cl. A22C 7/00

(52) U.S. Cl. 426/280; 426/513; 425/412; 425/173

(57) ABSTRACT

A hollowing apparatus for preparation of meat patties for cooking includes a mold assembly and a press assembly. The mold assembly has at least one wall, an open top, and a closed bottom. The press assembly is shaped to correspond matingly with the mold assembly such that the press assembly is configured to be at least partially placed within the mold assembly. The press assembly is pressable against a quantity of meat within the mold assembly so as to shape the quantity of meat into a meat patty.

### CROSS-REFERENCE TO RELATED APPLICATION

The present application is a U.S. nonprovisional patent application of, and claims priority under 35 U.S.C. §119(e) to, U.S. provisional patent application Ser. No. 61/254,816, filed Oct. 26, 2009, which provisional patent application is hereby incorporated by reference herein.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention generally relates to a hollowing apparatus for meat patties and, more specifically, to a hollowing apparatus for use in the preparation of meat patties for hamburgers and the like.

Hamburgers and similar types of sandwiches are a common meal prepared in homes and restaurants across many geographic areas. Typically, uncooked meat is formed into a meat patty by hand and is then grilled or cooked as desired. Once cooked, the meat patty is generally placed on a bun and topped with selected toppings or additional ingredients to add flavor or otherwise complement the meal.

However, the process of making meat patties by hand has shortcomings. For instance, when molding meat into patties by hand, it is often difficult to mold the meat patties to have a selected thickness, size, and shape. Furthermore, toppings placed on top of the meat patty have a tendency to become overcooked when cooked with the meat patty or slide off of the fully cooked meat patty.

Yet, the process of making meat patties by hand can become even more difficult when additional ingredients are stuffed into the interior of the meat patty by hand. If a meat patty is hollowed by hand or split apart to accommodate the inclusion of such ingredients prior to cooking, the meat patty may fall apart during the cooking process in view of problems such as a lack of thickness in one portion of the patty that causes the ingredients to spill or the meat patty to crumble.

Accordingly, a need exists for improvement in the field of meat patty preparation. This, and other needs, are addressed by one or more aspects of the present invention.

### SUMMARY OF THE INVENTION

The present invention includes many aspects and features. Moreover, while many aspects and features relate to, and are described in, the context of preparation of meat patties for hamburgers and sandwiches, the present invention is not limited to use only in this context, as will become apparent from the following summaries and detailed descriptions of aspects, features, and one or more embodiments of the present invention.

Broadly defined, the present invention according to a first aspect is a hollowing apparatus for preparation of meat patties substantially as shown and described.

Broadly defined, the present invention according to a second aspect is a hollowing apparatus for preparation of meat patties for cooking. The hollowing apparatus includes a mold portion and a press portion. The mold portion has at least one wall, an open top, and an open bottom. The press portion is shaped to correspond matingly with the mold portion such that the press portion is configured to be at least partially placed within the mold portion. The press portion is pressable against a quantity of meat within the mold portion so as to shape the quantity of meat into a meat patty.

In features of this aspect, each of the mold portion and the press portion may have a generally cylindrical shape; the press portion may include a grip configured for a user to hold while operating the press portion; the press portion may include a stamp for engaging the quantity of meat; the press portion may include a stop for preventing over-insertion of the press portion through the mold portion; the press portion may form a hollowed-out central area in the meat patty; and the meat patty may be formed to accommodate the inclusion of toppings or additional ingredients.

In features of this aspect, the meat patty may be formed to accommodate the inclusion of toppings or additional ingredients, and: the toppings or additional ingredients may include cheese; the toppings or additional ingredients may include a vegetable; the toppings or additional ingredients may include a sauce; the toppings or additional ingredients may include a pasta; the toppings or additional ingredients may include a bread; the toppings or additional ingredients may include a mushroom; the toppings or additional ingredients may include a spice; the toppings or additional ingredients may include a seasoning; and the toppings or additional ingredients may include another meat.

Broadly defined, the present invention according to a third aspect is a kit for preparation of a meat patty as substantially shown and described.

Broadly defined, the present invention according to a fourth aspect is a kit for preparation of a meat patty for cooking. The kit includes a hollowing apparatus having a mold portion and a first press portion shaped to correspond matingly with the mold portion. A first quantity of meat within the mold portion is pressable with the first press portion to form the first quantity of meat into a first meat patty having a hollowed-out central area for accommodating toppings or additional ingredients. Additionally, the kit includes a second press portion shaped to correspond matingly and fit snugly within the mold portion. A second quantity of meat within the mold portion is pressable with the second press portion to form the second quantity of meat into a second meat patty without a hollowed-out central area.

In features of this aspect, each of the first and second press portions may include a grip configured for a user to hold during operation; each of the first and second press portions may include a stop for preventing over-insertion through the mold portion; each of the first and second press portions may include a stamp for engaging with and pressing meat; and each of the mold portion, the first press portion, and the second press portion may have a generally cylindrical shape.

Broadly defined, the present invention according to a fifth aspect is a method of stuffing a meat patty with toppings or ingredients before cooking, as substantially shown and described.

Broadly defined, the present invention according to a sixth aspect is a method of using a hollowing apparatus as substantially shown and described.

Broadly defined, the present invention according to a seventh aspect is a method of using a hollowing apparatus in the preparation of a meat patty for cooking. The method includes the steps of placing a first quantity of meat into an interior of a mold portion having at least one wall, an open top, and an open bottom; positioning a press portion, shaped to correspond matingly with the mold portion, through the mold portion; and pressing and forming the quantity of meat with the press portion into a first meat patty having a hollowed-out central area.

In features of this aspect, the method may further comprise the steps of placing a second quantity of meat into the interior of the mold portion; and pressing and forming the second quantity of meat with the press portion into a second meat patty having a hollowed-out central area. In further features of this aspect, the method may further comprise the step of placing toppings or additional ingredients in the hollowed-out central area of either of the first or second meat patties, and the method may further comprise the step of arranging the first meat patty relative to the second meat patty such that the hollowed-out central areas are facing one another and the toppings or additional ingredients are fully covered.

In still further features of this aspect, each of the mold portion and the press portion may have a generally cylindrical shape; the press portion may include a grip configured for a user to hold while operating the press portion; the press portion may include a stamp for engaging the first quantity of meat; and the press portion may include a stop for preventing over-insertion of the press portion through the mold portion.

Another aspect of the present invention relates to a hollowing apparatus for preparation of meat patties for cooking. An exemplary such apparatus includes a mold assembly having at least one wall, an open top, and a closed bottom, and a press assembly shaped to correspond matingly with the mold assembly such that the press assembly is configured to be at least partially placed within the mold assembly. Furthermore, the press assembly is pressable against a quantity of meat within the mold assembly so as to shape the quantity of meat into a meat patty.

In a feature of this aspect of the invention, each of the mold assembly and the press assembly have a generally cylindrical shape.

In another feature of this aspect, the press assembly includes a handle configured for a user to hold while operating the press assembly.

In yet another feature, the press assembly is adapted to form generally flat, circular meat patties.

In still another feature, the press assembly is adapted to form meat patties with a hollowed-out central area.

In a further feature of this aspect of the present invention, the press assembly transitions between a first configuration and a second configuration; wherein in first configuration the press assembly is adapted to form meat patties with a hollowed-out central area; and wherein in the second configuration the press assembly is adapted to form generally flat, circular meat patties. In a variation of this feature, the press assembly transitions from the first configuration to the second configuration by attaching a burger press to the press assembly.

In yet another feature, the mold assembly comprises a rim defining the at least one wall and a serve tray defining the closed bottom.

In still another feature, the press assembly includes a stop for preventing over-insertion of the press assembly through the mold assembly.

In a further feature, the mold assembly includes one or more measuring lines to indicate the maximum quantity of meat to be loaded into the mold assembly.

In still another feature, the press assembly includes a stuffer press permanently attached to the press assembly and a burger press removably attached to the press assembly. In a variation of this feature, the burger press is removably attached to the press assembly by a three-point locking system.

In a further feature still, the meat patty is formed to accommodate the inclusion of toppings or additional ingredients.

Another aspect of the present invention relates to a method of preparing a meat patty for cooking. An exemplary such method includes providing a mold assembly having at least one wall, an open top, and a closed bottom, and a press assembly shaped to correspond matingly with the mold assembly such that the press assembly is configured to be at least partially placed within the mold assembly. Such a method further includes loading a first quantity of meat within the mold assembly, and pressing the press assembly against the first quantity of meat within the mold assembly so as to shape the first quantity of meat into a first meat patty.

In a feature of this aspect of the invention, the method further includes the step of pressing the press assembly against the first meat patty to form a hollowed-out central area.

In a variation of this feature, the method further includes the step removing the first meat patty from the mold assembly.

In yet another variation of this feature, the method includes the step of placing toppings in the hollowed-out central area.

In still another variation, the method includes the steps of loading a second quantity of meat within the mold assembly, pressing the press assembly against the second quantity of meat within the mold assembly so as to shape the second quantity of meat into a second meat patty, and removing the second meat patty from the mold assembly, and placing the second meat patty above the first meat patty so as to cover the toppings housed in the hollowed-out central area.

Another aspect of the present invention relates to a hollowing apparatus for preparation of meat patties. An exemplary such apparatus includes a serve tray, including a flat base portion, a cylindrical rim, including an open top and an open bottom, a press assembly, having a handle and a stuffer press, the stuffer press being permanently attached to the handle, and a burger press, the burger press being removably attachable to the press assembly. Furthermore, the cylindrical rim is slidably attachable to the serve tray such that the flat base portion covers the open bottom to form a mold assembly into which a quantity of meat may be inserted. Further still, the press assembly with the burger press removably attached thereto is pressable against the quantity of meat within the mold assembly so as to shape the quantity of meat into a meat patty. Also, the press assembly without the burger press removably attached thereto is pressable against the meat patty so as to form a hollowed-out central area in the meat patty capable of housing ingredients therein.

In addition to the aforementioned aspects and features of the present invention, it should be noted that the present invention further encompasses the various possible combinations and subcombinations of such aspects and features.

### BRIEF DESCRIPTION OF THE DRAWINGS

One or more preferred embodiments of the present invention now will be described in detail with reference to the accompanying drawings, wherein the same elements are referred to with the same reference numerals, and wherein:

FIG. 1 is perspective view of a preferred embodiment of a hollowing apparatus in accordance with one or more aspects of the present invention;

FIG. 2 is a perspective view of the mold portion of the hollowing apparatus shown in FIG. 1;

FIG. 3 is a front view of the mold portion of FIG. 2;

FIG. 4 is a top view of the mold portion of FIG. 2;

FIG. 5 is a cross-sectional view of the mold portion of FIG. 2, taken along line 4-4;

FIG. 6 is a perspective view of the press portion of the hollowing apparatus shown in FIG. 1;

FIG. 7 is a front view of the press portion of FIG. 6;

FIG. 8 is a top view of the press portion of FIG. 6;

FIGS. 9-16 are cross-sectional views illustrating the use of the hollowing apparatus of FIG. 1;

FIG. 17 is a cross-sectional view of an alternative embodiment of the press portion;

FIG. 18 is a perspective view of a second preferred embodiment of a hamburger hollowing apparatus in accordance with one or more aspects of the present invention;

FIG. 19 is an exploded perspective view of the hamburger hollowing apparatus of FIG. 18;

FIG. 20 is a perspective view of a burger press assembly in accordance with one or more aspects of the present invention;

FIG. 21 is a perspective view of a burger press and a hollowing press assembly in accordance with one or more aspects of the present invention;

FIG. 22 is a top plan view of the hamburger hollowing apparatus of FIG. 18;

FIG. 23 is a side plan view of the hamburger hollowing apparatus of FIG. 18;

FIG. 24 front plan view of the hamburger hollowing apparatus of FIG. 18; and

FIG. 25 is a cross sectional view taken along line 25-25 of FIG. 22.

### DETAILED DESCRIPTION

As a preliminary matter, it will readily be understood by one having ordinary skill in the relevant art (“Ordinary Artisan”) that the present invention has broad utility and application. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112, ¶6, no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Referring now to the drawings, one or more preferred embodiments of the present invention are next described. The following description of one or more preferred embodiments is merely exemplary in nature and is in no way intended to limit the invention, its implementations, or uses.

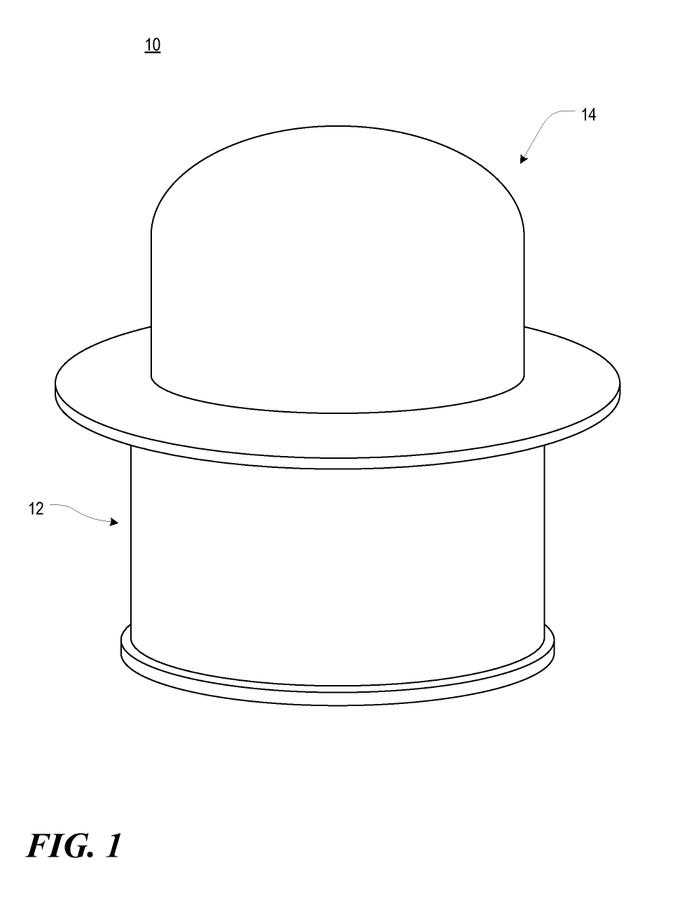

FIG. 1 is a perspective view of a first preferred embodiment of a hamburger hollowing apparatus in accordance with one or more aspects of the present invention. The burger hollowing apparatus 10 is comprised of a mold portion 12 and a press portion 14. While the mold portion 12 is depicted as having an annular, generally cylindrical shape, it is contemplated that the mold portion 12 may be any of a range of different shapes. The apparatus 10 may be used to shape a meat patty that is pressed and hollowed for stuffing with toppings or ingredients.

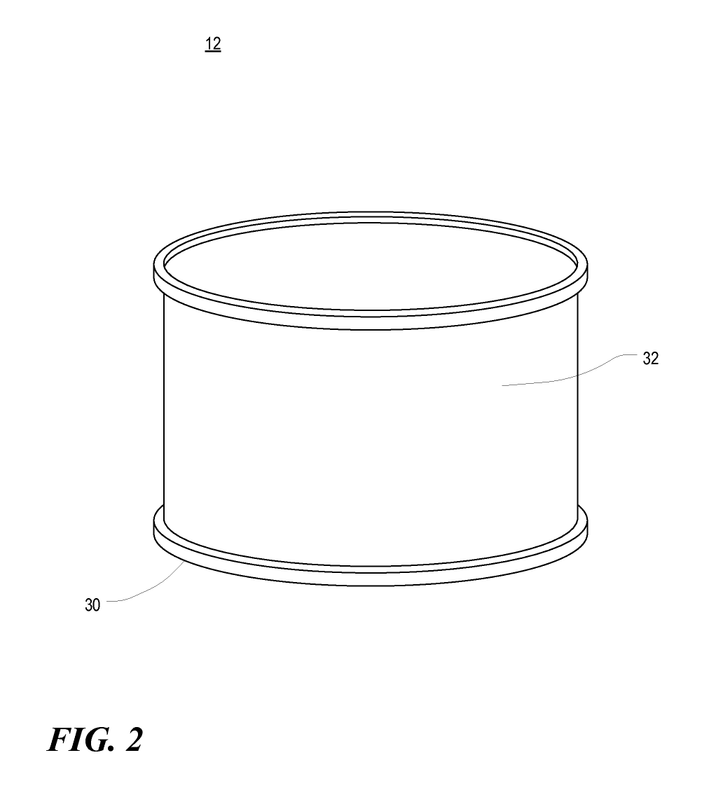

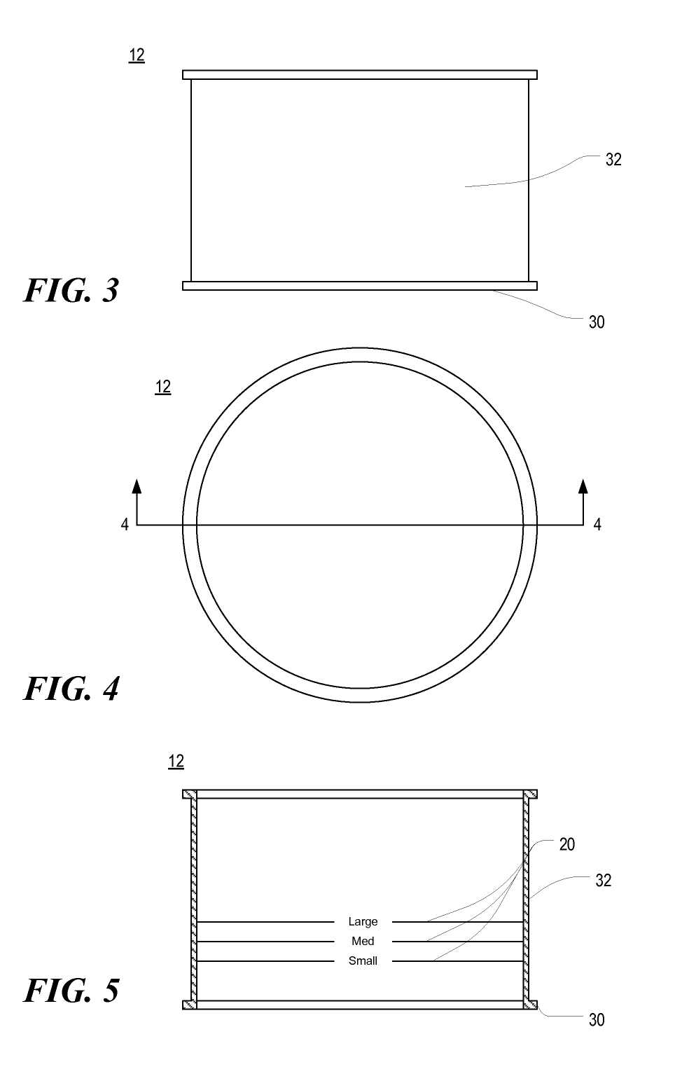

FIG. 2 is a perspective view of the mold portion 12 shown in FIG. 1. FIG. 3 is a front view of the mold portion 12 of FIG. 2; FIG. 4 is a top view of the mold 12 of FIG. 2; and FIG. 5 is a cross-sectional view of the mold portion 12 of FIGS. 3 and 4, taken along line 4-4. As shown in FIGS. 2-5, the mold portion 12 is open at the top and bottom and has an annular, generally cylindrical shape. In this regard, the mold portion 12 may be used to provide meat patties with at least a generally circular or round shape. The bottom edge 30 of the mold portion 12 is flat and configured to rest against a flat surface, such as a plate, a piece of tinfoil, or a countertop. One or more side walls 32 of the mold portion 12 are generally rigid and may be comprised of metal, plastic, ceramic, or other generally rigid material. As shown specifically in FIG. 5, the interior surface of the mold portion 12 includes measuring lines 20 that are used to indicate the appropriate levels to which the mold portion 12 may be filled in order to prepare a meat patty of a selected size. Each measuring line 20 may be marked with the corresponding size of the meat patty to be formed, such as small, medium or large. While three measuring lines 20 are depicted in FIG. 5, it is contemplated that additional measuring lines 20 may be included in the mold portion 12. Furthermore, the mold portion 12 may be used as a cutter tool capable of cutting away a portion of a large quantity of meat to be used in the preparation of a meat patty.

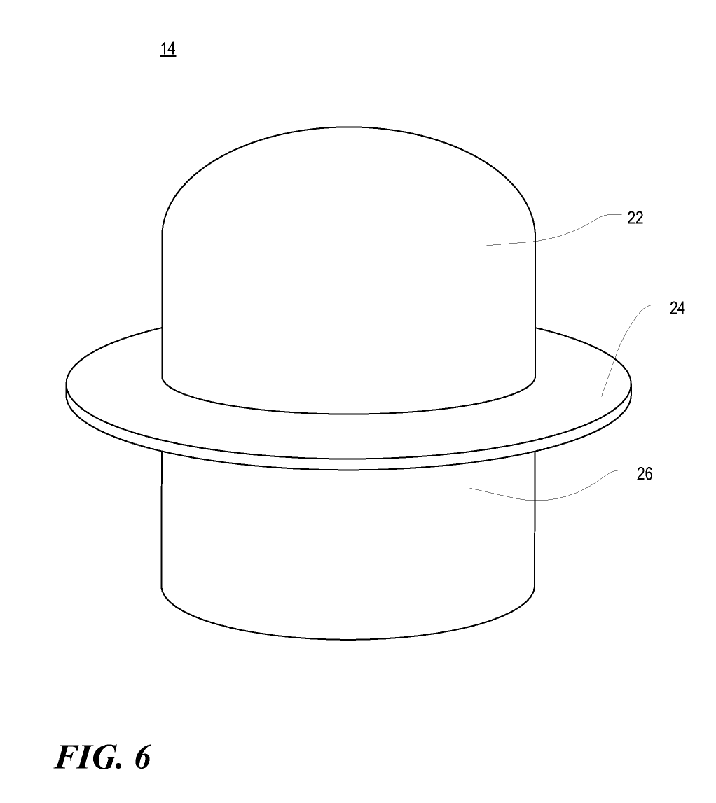

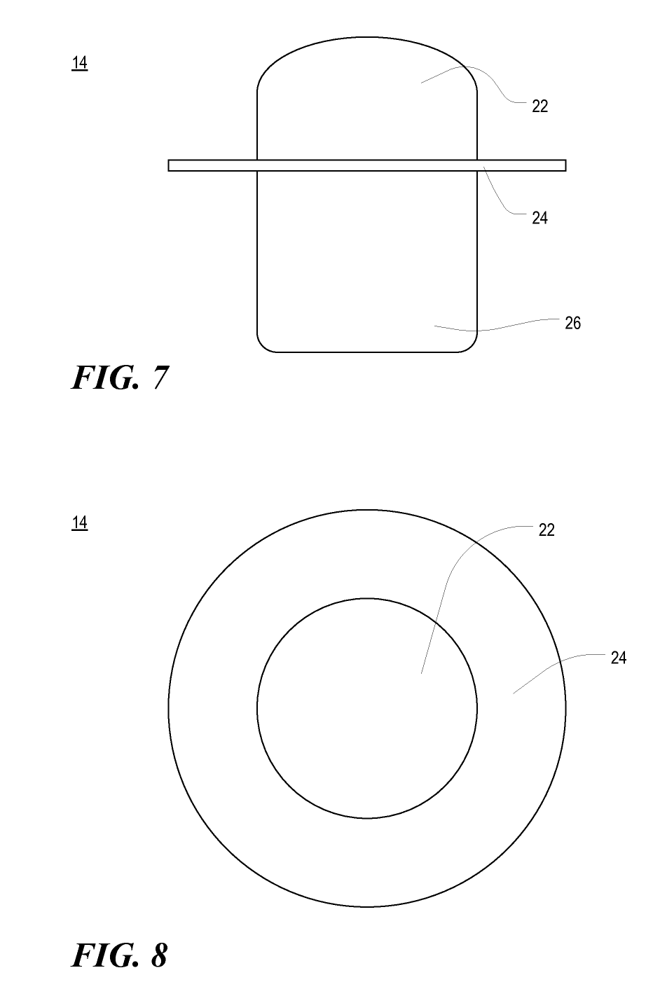

FIG. 6 is a perspective view of the press portion 14 shown in FIG. 1. FIG. 7 is a front view of the press portion 14 of FIG. 6, and FIG. 8 is a top view of the press portion 14 of FIG. 6. The press portion 14 is shaped and dimensioned to mate with the mold portion 12 and is configured to be at least partially placed within the mold portion 12. As shown in FIGS. 6-8, the press portion 14 has a generally cylindrical shape which corresponds with the generally cylindrical shape of the mold portion 12 shown in FIGS. 2-5. It is further contemplated that the press portion 14 may be any of a range of different shapes so as to mate with a corresponding mold portion having a matching shape.

As further shown in FIGS. 6-8, the press portion 14 is comprised of a grip 22, a stamp 26, and a stop 24. The grip 22 is shaped as a knob at the top of the press portion 14 that is configured for a user to hold while the user is operating the press portion 14. The stamp 26 is located at the base of the press portion 14 and is configured to be inserted through the top opening of the mold portion 12. Upon insertion through the top opening of the mold portion 12, the stamp 26 is used to press against and alter the shape of a meat patty half 18 inside the mold portion 12 so as to create a hollowed-out central area in the meat patty half 18. The stop 24 is configured as a small plate or ring extending radially outwardly from the press portion 14 and generally separates the grip 22 from the stamp 26. When the press portion 14 is in use, the stop 24 prevents the grip 22 from entering the interior portion of the mold portion 12, and thereby helps to avoid over-insertion of the press portion 14 through the mold portion 12.

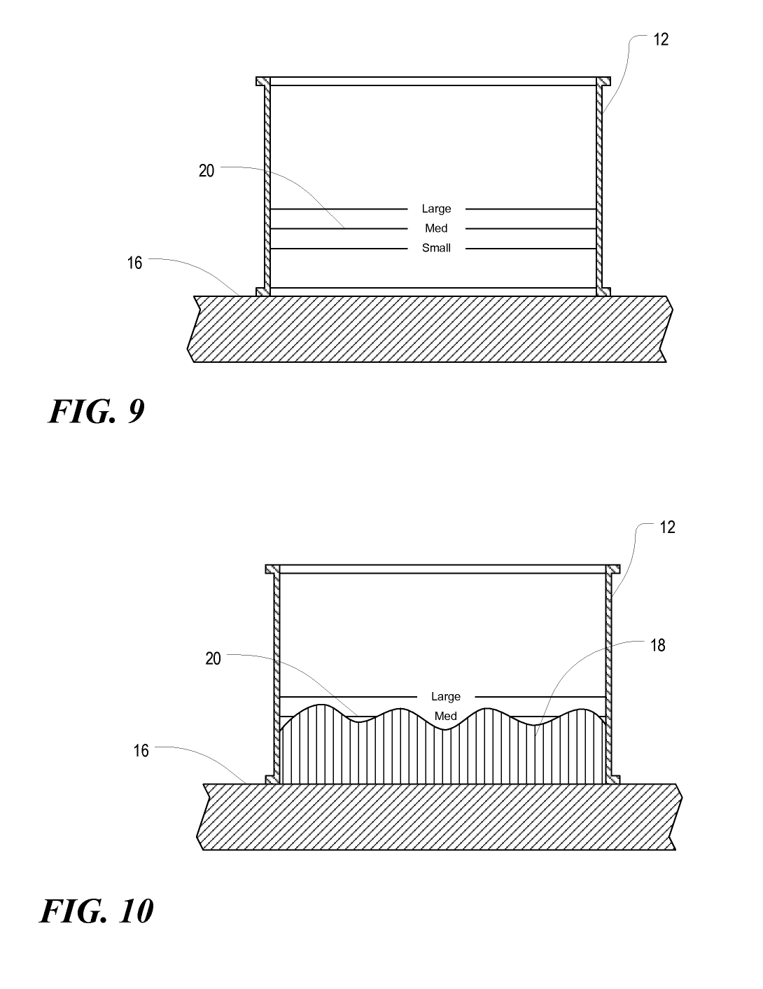

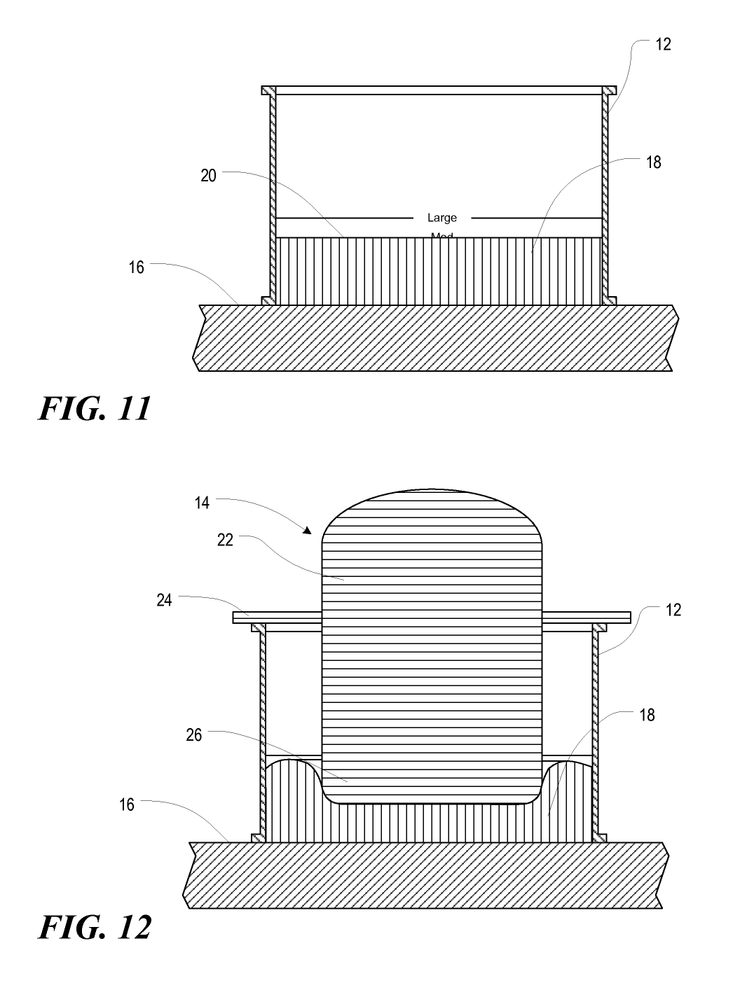

FIGS. 9-16 are cross-sectional illustrations showing the operation of the hollowing apparatus 10 and a method of using the hollowing apparatus 10. In FIG. 9, the mold portion 12 has been placed on a surface 16, such as a tabletop or a counter, in preparation of use. In FIG. 10, a meat patty half 18 has been inserted into the mold portion 12. In FIG. 11, the meat patty half 18 has been compressed by a user within the mold portion 12 to form and settle against the interior surface of the mold portion 12 and the surface 16 beneath the mold portion 12. The user may have accomplished this with his or her finger, with a spoon, or with any other appropriate device. A sufficient amount of meat has been loaded into the mold to reach one of the measuring lines 20 so that the formed meat patty has a selected size. The user has the option to remove any excess meat that reaches above the measuring line 20. Meat patties of larger and smaller sizes may be prepared by filling the mold portion 12 to different measuring lines.

In FIG. 12, the press portion 14 has been inserted into the mold portion 12 so as to hollow out the central area of the meat patty half 18 arranged therein. The stamp 26 of the press portion 14 pushes against the meat patty half 18 at the bottom of the mold portion 12, altering the shape of the meat patty half 18 by hollowing out the central area. It will be appreciated that the press portion 14 avoids over-pressing the meat patty half 18. Over-pressing the meat patty half 18 may cause the patty half 18 to be too thin to support toppings or ingredients that are placed onto the meat patty half 18 during preparation and are ultimately contained within the meat patty once fully formed. If the meat patty half 18 is too thin, toppings or ingredients that have been added have a greater chance of spilling out of the meat patty during cooking. As further shown in FIG. 12, the stop 24 prevents the press portion 14 from being over-inserted into the mold portion 12, and thereby facilitates prevention of over-pressing of the meat 18.

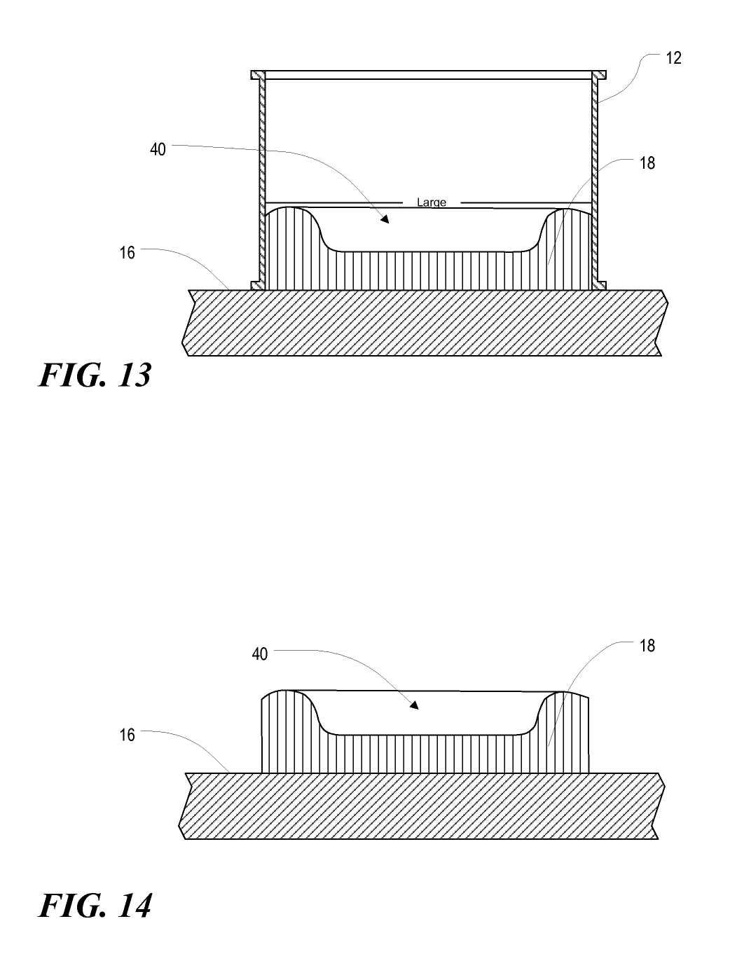

In FIG. 13, the press portion 14 has been removed from the mold portion 12, and the meat patty half 18 remains at the bottom of the mold portion 12. In FIG. 14, the mold portion 12 has been removed so that the meat patty half 18 remains on the surface 16. The meat patty half 18 has a hollowed-out central area 40 for accommodating the addition of toppings or additional ingredients. Once the first meat patty half 18 has been formed and hollowed, the steps can be repeated in order to prepare a second meat patty half 18 in the same manner.

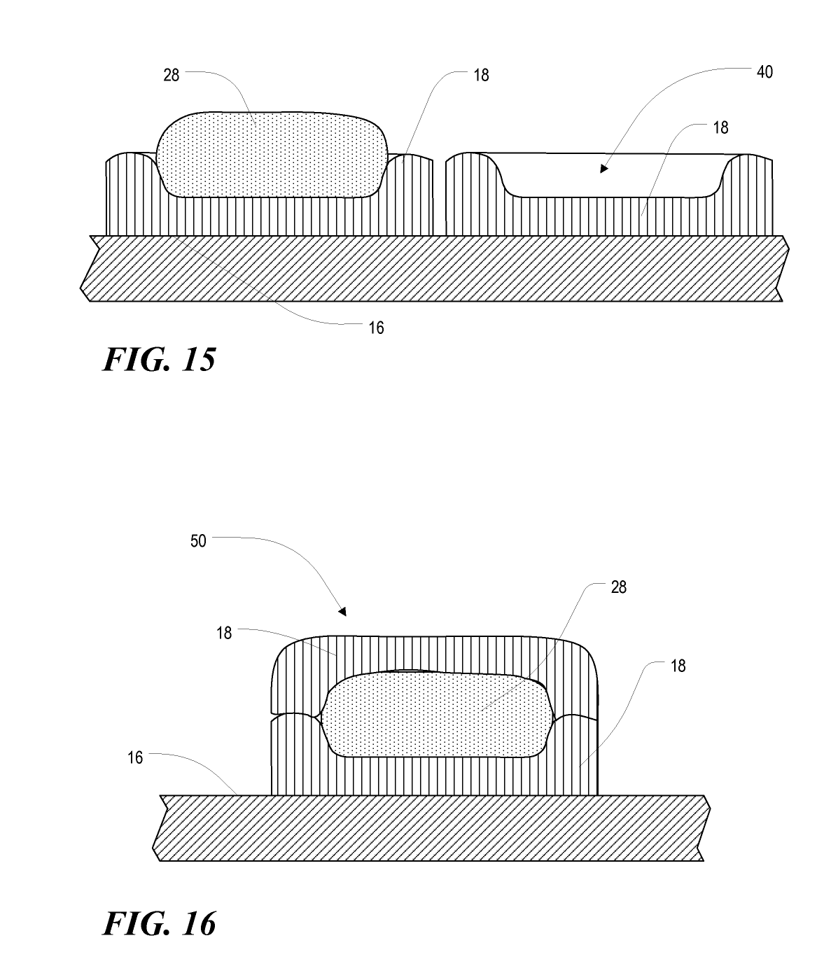

In FIG. 15, two meat patty halves 18, each with a hollowed-out central area 40 are situated on the surface 16. Toppings or additional ingredients 28 have been added to the hollowed-out central area 40 of one of the meat patty halves. In FIG. 16, the meat patty halves 18 are placed together with the hollowed-out central areas 40 facing one another to form a meat patty 50. In this regard, the toppings or additional ingredients 28 are fully covered and contained within the meat patty 50 formed from the two meat patty halves 18. Once fully formed, the meat patty 50 is stuffed with the selected toppings or ingredients 28 and is ready to be cooked. The meat patty 50 may be cooked in a variety of different ways, including grilling or frying.

A variety of different kinds of toppings or ingredients 28 are contemplated, including, but not limited to: cheeses; onions and other vegetables; bacon bits and other types of meat; mushrooms; spices and seasonings; sauces, such as barbecue sauce or steak sauce; pastas, such as macaroni and cheese; croutons and other breads, and various toppings commonly associated with burger preparation. As the meat patty 50 is cooked, toppings or additional ingredients 28 stuffed in the meat patty 50 will cook or be heated at the same time. For example, cheeses may melt, vegetables may be cooked, bacon bits and other meats may simmer, and spices and seasonings may be soaked into the meat patty 50 to add flavor.

After cooking, the meat patty 50 may be consumed. In one contemplated embodiment, the meat patty 50 may be used in connection with a bun in order to prepare a burger, such as a hamburger or turkey burger. However, the meat patty 50 is not limited for use in connection with the preparation of a burger, as other types of sandwiches are also contemplated.

A wide range of uncooked meats may be used in connection with the hallowing apparatus 10. For example, in one contemplated embodiment, uncooked beef is molded and pressed using the hollowing apparatus 10 in order to prepare a beef patty having a preferred shape and size and containing a selected grouping of toppings or other ingredients. Further, although description is provided herein with reference to “meat patties”, other substances commonly formed into patties, such as, for example, seafood (e.g. salmon), or substances commonly formed into veggie burgers (e.g. tofu), may similarly be utilized.

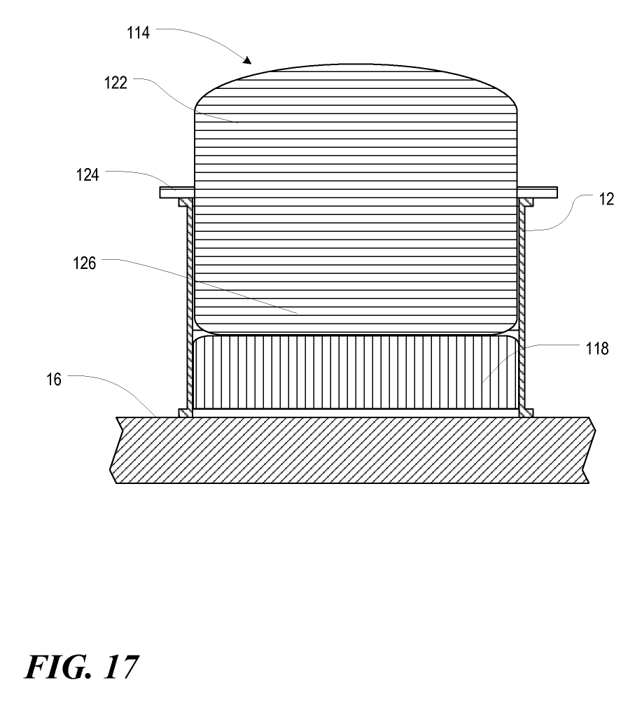

FIG. 17 is a cross-sectional view of an alternative embodiment of the press portion 114. As shown in FIG. 17, a press portion 114 may have a grip 122 and a stamp 126 sized and shaped to fit snugly through the corresponding mold portion 12. In this regard, the press portion 114 may be used to press a meat patty 118 without creating a hollowed-out central area. The stop 124 prevents the grip 122 from entering the interior portion of the mold portion 12, and thereby helps to avoid over-insertion of the press portion 114 through the mold portion 12. The resulting relatively flat meat patty 118 may be used alone for preparation of a hamburger or other sandwich without toppings or ingredients stuffed therein. Furthermore, the resulting meat patty 118 may be pressed again with the press portion 18 shown in FIGS. 6-8 in order to create a meat patty half 18 with a hollowed-out central area 40 for accommodating toppings or additional ingredients 28.

It is contemplated that the press portion 114 may be packaged together with the press portion 14 and mold portion 12 of the hollowing apparatus 10 and sold as a kit, thereby providing the user with press portions 14,114 useful in preparing both meat patties stuffed with toppings or additional ingredients and meat patties without toppings or additional ingredients.

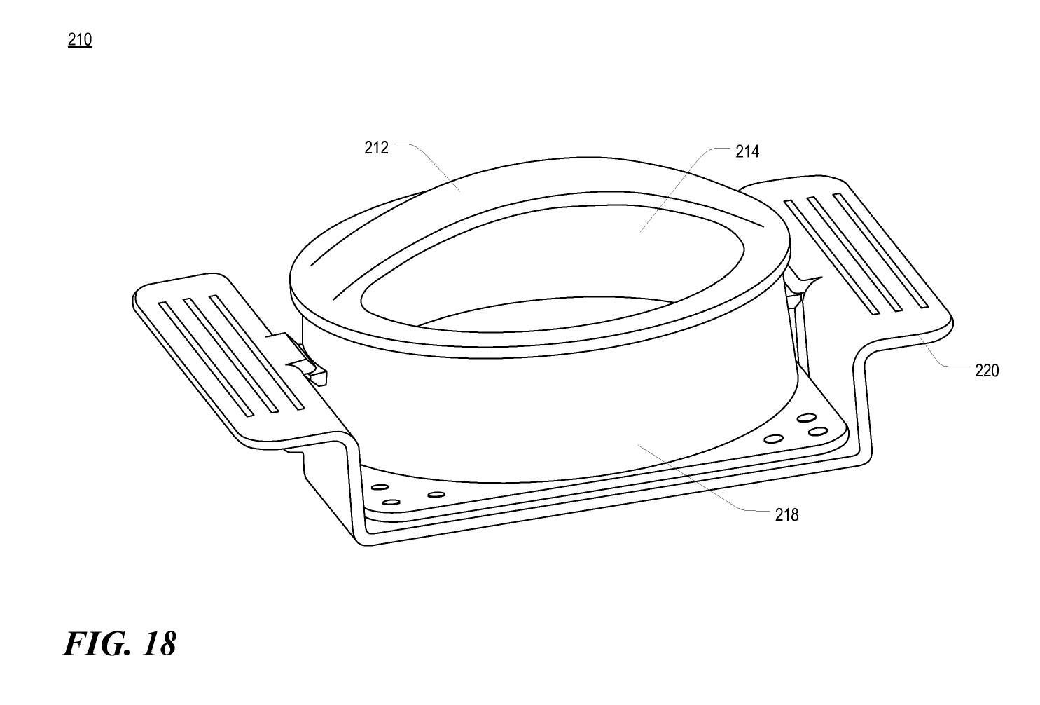

FIG. 18 is a perspective view of a second preferred embodiment of a burger hollowing apparatus in accordance with one or more aspects of the present invention. The burger hollowing apparatus 210 is comprised of a handle 212, a stuffer press 214 permanently affixed to the handle 212, a burger press 216, a rim 218, and a serve tray 220. While the rim 218 is depicted as having an annular, generally cylindrical shape, it is contemplated that the rim 218 may be any of a range of different shapes. The apparatus 210 may be used to shape a meat patty that is pressed and hollowed for stuffing with toppings or ingredients.

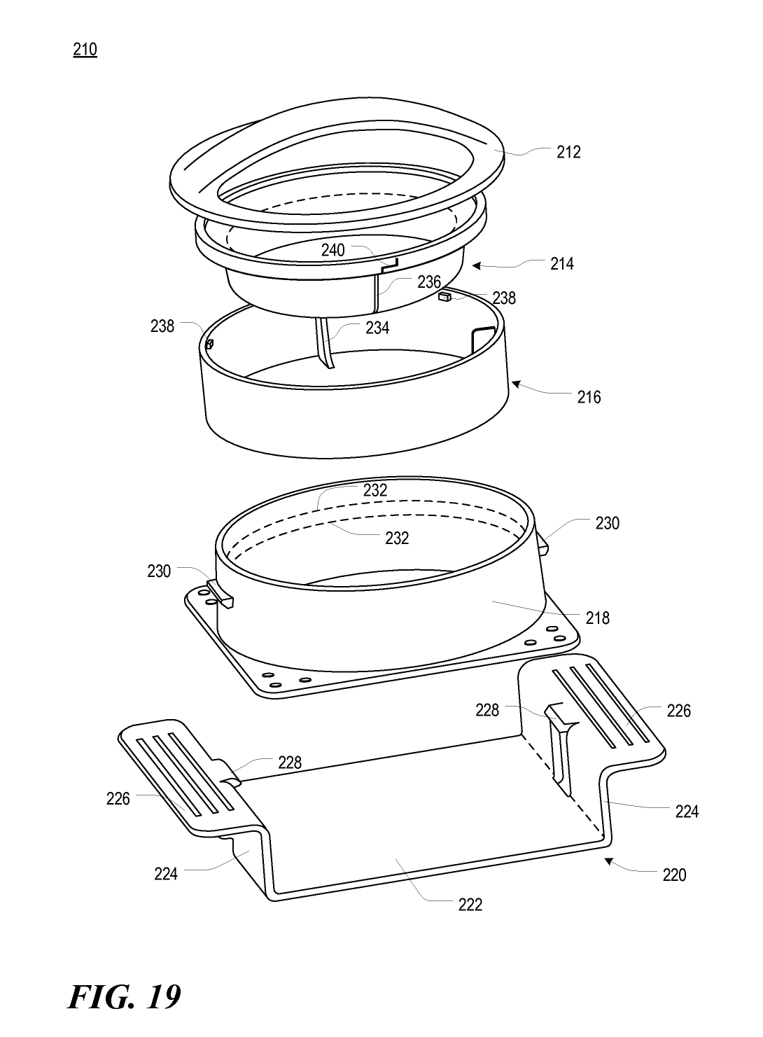

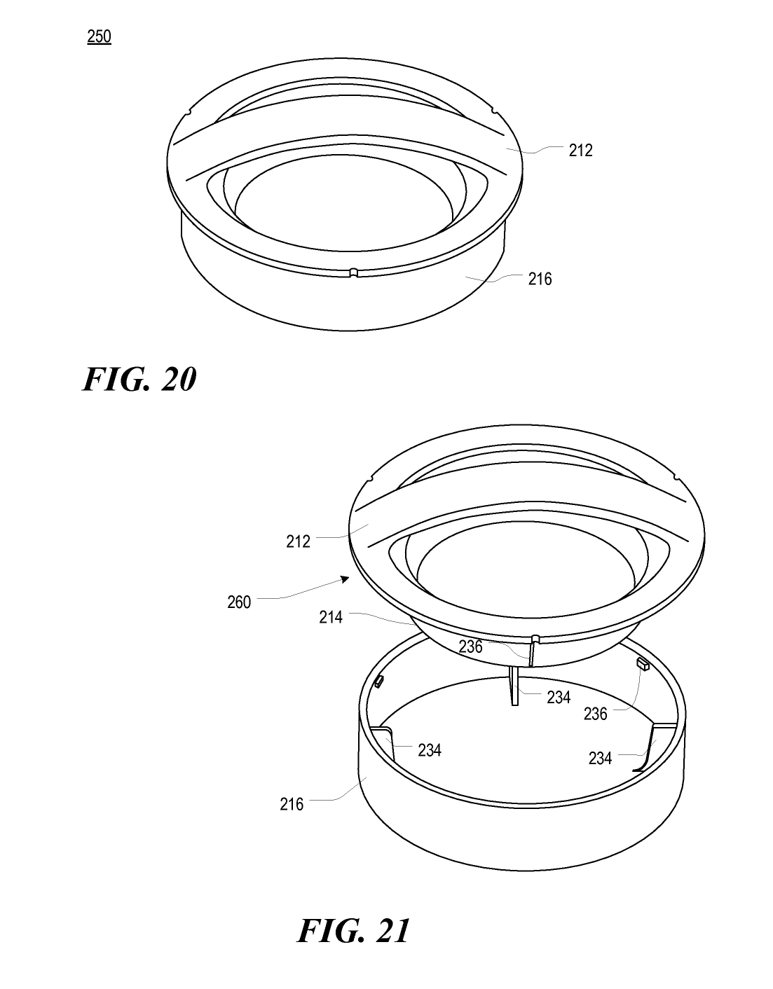

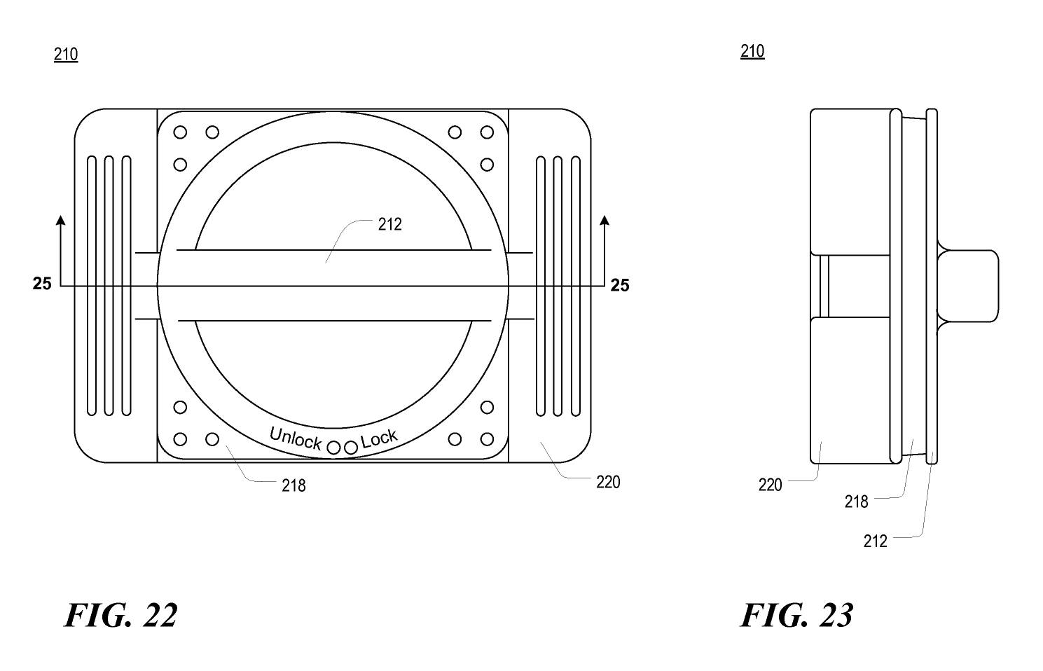

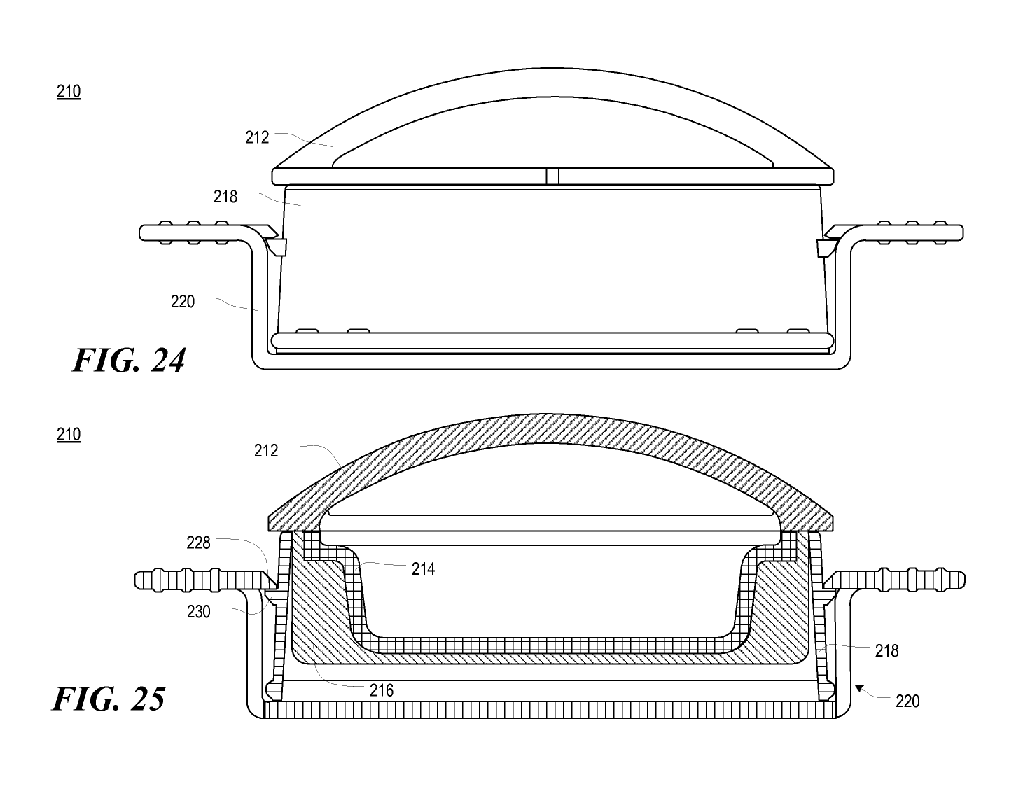

FIG. 19 is an exploded perspective view of the burger hollowing apparatus 210 shown in FIG. 1. FIG. 20 is a perspective view of the handle 212 and stuffer press 214 removably attached to the burger press 216. FIG. 21 is a perspective view of the handle 212 and stuffer press 214 disengaged from the burger press 216. FIG. 22 is a top plan view of the apparatus 210. FIG. 23 is a side plan view of the apparatus 210. FIG. 24 is a front plan view of the burger hollowing apparatus 210. FIG. 25 is a cross sectional view taken along line 25-25 as seen in FIG. 22.

As perhaps best seen in FIG. 19, the serve tray 220 includes a square bottom 222, two generally vertical walls 224 extending from opposing sides of the square bottom 222, each vertical wall 224 ending in a generally horizontal outwardly-extending lip 226. Each lip 226 includes an inwardly projecting tab 228.

The rim 218 is a generally cylindrical member atop a generally square base and is open at both the top and bottom. The rim 218 is slightly tapered such that the diameter of the top opening is smaller than the diameter of the bottom opening. The square base is approximately the same size as the square bottom 222 of the serve tray 220. The outer surface of the rim 218 comprises two diametrically-opposed, outwardly projecting tabs 230. As shown most clearly in FIG. 18, the rim 218 is configured to attach to the serve tray 220. The rim 218 is attached by sliding the square base of the rim 218 along the top of the square bottom 222 of the serve tray 220 toward the center of the serve tray 220 until the outwardly-projecting tabs 230 of the rim 218 are positioned immediately below the inwardly-projecting tabs 228 of the serve tray 220, so as to prevent movement of the rim 218 in a vertical direction. The rim 218 may be detached from the serve tray 220 by sliding the rim 218 laterally.

When secured together, the rim 218 and serve tray 220 act as a mold assembly for forming meat patties with a generally circular or round shape. The interior surface of the rim 218 comprises one or more measuring lines 232 used to indicate appropriate levels to which the mold assembly may by filled in order to prepare a meat patty of a selected size. Each measuring line 232 may be marked with the corresponding size of the meat patty to be formed, such as small, medium and large; or one fourth (¼) of a pound, one third (⅓) of a pound, and one half (½) of a pound. Alternatively, or in addition to, measuring lines indicating meat patty size, a first measuring line 232 may be provided to indicate the depth of insertion of the burger press 216, and a second measuring line 232 may be provided to indicate the depth of insertion of the stuffer press 214. While two measuring lines 232 are depicted in FIG. 19, it is contemplated that additional measuring lines 232 may be included on the interior of the rim 218.

FIG. 20 is a perspective view of the handle 212 and stuffer press 214 removably attached to the burger press 216 to form a burger press assembly 250. FIG. 21 is a perspective view of the handle 212 and stuffer press 214 disengaged from the burger press 216, the handle 212 and stuffer press 214 together forming a hollowing press assembly 260. Both the burger press assembly 250 and the hollowing press assembly 260 are configured for use in conjunction with the mold assembly. The burger press assembly 250 is used to form flat, generally circular meat patties. The hollowing press assembly 260 is used to form a meat patty with a concave or hollowed-out central area that may be stuffed with various ingredients or toppings. It is contemplated that the burger press assembly 250 and hollowing press assembly 260 can be used in sequence to first create a consistently flat, circular meat patty, and then to hollow out an interior portion of that meat patty for stuffing.

The hollowing press assembly 260 is formed by the handle 212 and the stuffer press 214 which are permanently affixed to one another. The burger press assembly 250 is formed by attaching the burger press 216 to the hollowing press assembly 260 via a locking system. In at least one preferred embodiment, the locking system is a three point locking system comprising three vertical guide members 234 located on the interior surface of the burger press 216 configured to mate with grooves 236 in the outer surface of the stuffer press 214. The three point locking system further comprises three locking members 238 on the interior surface of the burger press 216 configured to mate with corresponding notches 240 on the exterior of the stuffer press 214. The user may lock the locking members 238 into the notches 240 by twisting the handle 212 to the locked position, as shown in FIG. 22. The mating of the guide members 234 to the grooves 236 and the locking members 238 to the notches 240 secures the burger press 216 to the hollowing press assembly 260 to form the burger press assembly 250.

It will be appreciated that the burger hollowing apparatus 210 operates in a manner similar to the burger hollowing apparatus 10; however, there are several differences discussed hereinbelow. First, the rim 218 must be slid into the serve tray 220 to form the mold assembly. Next, a quantity of meat (and/or other substance) is inserted into the mold assembly up to a desired measuring line 232. The quantity of meat is then formed into a flat, circular meat patty by inserting the burger press assembly 250 into the mold assembly and pressing the quantity of meat therein. Next, the burger press 216 is removed from the hollowing press assembly 260. The hollowing press assembly 260 is then used to hollow-out a central area of the meat patty within the mold assembly. Next, the rim 218, containing the meat patty therein, is slidably removed from the serve tray 220. Once removed, the rim 218 is lifted from the meat patty, a step facilitated by the slightly tapered shape of the rim 218. This first meat patty forms half of the final burger. The entire process is then repeated to form the second half of the burger. To complete the process, the two meat patties are joined. At some point after forming the first half, but prior to joining the two halves, ingredients may be added to the hollowed-out center portion of one of the meat patties.

As can now be appreciated, the hollowing apparatus 210 enables the user to mold and press meat patties of a particular thickness, size, and shape in a consistent manner. Additionally, the hollowing apparatus 210 enables the user to make meat patties that can be stuffed with selected toppings or additional ingredients with relative ease. In view of the consistency in the meat patty thickness, size, and shape, the meat patty is better suited to remain assembled during the cooking process, thereby permitting toppings or additional ingredients stuffed therein to be cooked or heated as appropriate without spilling from the meat patty.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1. A hollowing apparatus for preparation of meat patties for cooking, comprising:
a. a mold assembly having at least one wall, an open top, and a closed bottom; and
b. a press assembly shaped to correspond matingly with the mold assembly such that the press assembly is configured to be at least partially placed within the mold assembly;
c. wherein the press assembly is pressable against a quantity of meat within the mold assembly so as to shape the quantity of meat into a meat patty.

2. The hollowing apparatus of claim 1, wherein each of the mold assembly and the press assembly have a generally cylindrical shape.

3. The hollowing apparatus of claim 1, wherein the press assembly includes a handle configured for a user to hold while operating the press assembly.

4. The hollowing apparatus of claim 1, wherein the press assembly is adapted to form generally flat, circular meat patties.

5. The hollowing apparatus of claim 1, wherein the press assembly is adapted to form meat patties with a hollowed-out central area.

6. The hollowing apparatus of claim 1, wherein the press assembly transitions between a first configuration and a second configuration; wherein in first configuration the press assembly is adapted to form meat patties with a hollowed-out central area; and wherein in the second configuration the press assembly is adapted to form generally flat, circular meat patties.

7. The hollowing apparatus of claim 6, wherein the press assembly transitions from the first configuration to the second configuration by attaching a burger press to the press assembly.

8. The hollowing apparatus of claim 1, wherein the mold assembly comprises a rim defining the at least one wall and a serve tray defining the closed bottom.

9. The hollowing apparatus of claim 1, wherein the press assembly includes a stop for preventing over-insertion of the press assembly through the mold assembly.

10. The hollowing apparatus of claim 1, wherein the mold assembly includes one or more measuring lines to indicate the maximum quantity of meat to be loaded into the mold assembly.

11. The hollowing apparatus of claim 1, wherein the mold assembly includes one or more measuring lines to indicate the depth to which the press assembly may be inserted.

12. The hollowing apparatus of claim 1, wherein the press assembly includes a stuffer press permanently attached to the press assembly and a burger press removably attached to the press assembly.

13. The hollowing apparatus of claim 12, wherein the burger press is removably attached to the press assembly by a three-point locking system.

14. The hollowing apparatus of claim 1, wherein the meat patty is formed to accommodate the inclusion of toppings or additional ingredients.

15-23. (canceled)

24. A kit for preparation of a meat patty for cooking, the kit comprising:
a. a hollowing apparatus having a mold portion and a first press portion shaped to correspond matingly with the mold portion, wherein a first quantity of meat within the mold portion is pressable with the first press portion to form the first quantity of meat into a first meat patty having a hollowed-out central area for accommodating toppings or additional ingredients; and
b. a second press portion shaped to correspond matingly and fit snugly within the mold portion, wherein a second quantity of meat within the mold portion is pressable with the second press portion to form the second quantity of meat into a second meat patty without a hollowed-out central area.

25-28. (canceled)

29. A method of preparing a meat patty for cooking, comprising:
a. providing:
i. a mold assembly having at least one wall, an open top, and a closed bottom; and
ii. a press assembly shaped to correspond matingly with the mold assembly such that the press assembly is configured to be at least partially placed within the mold assembly;
b. loading a first quantity of meat within the mold assembly; and
c. pressing the press assembly against the first quantity of meat within the mold assembly so as to shape the first quantity of meat into a first meat patty.

30. The method of preparing a meat patty for cooking of claim 29, further comprising the step of pressing the press assembly against the first meat patty to form a hollowed-out central area.

31. The method of preparing a meat patty for cooking of claim 30, further comprising the step removing the first meat patty from the mold assembly.

32. The method of preparing a meat patty for cooking of claim 31, further comprising the step of placing toppings in the hollowed-out central area.

33. The method of preparing a meat patty for cooking of claim 32, further comprising the steps of:
a. loading a second quantity of meat within the mold assembly;
b. pressing the press assembly against the second quantity of meat within the mold assembly so as to shape the second quantity of meat into a second meat patty; and
c. removing the second meat patty from the mold assembly; and
d. placing the second meat patty above the first meat patty so as to cover the toppings housed in the hollowed-out central area.

34. (canceled)
